(19) United States
(12) Patent Application Publication
(10) Pub. No.: US 2007/0168059 A1
(43) Pub. Date: Jul. 19, 2007

(54) Display and operation system and method for a machine in the tobacco-processing industry

(75) Inventors: Karsten Eckert, Hamburg (DE); Jurgen Wendner, Hamburg (DE)

Correspondence Address: VENABLE LLP, P.O. BOX 34385, WASHINGTON, DC, 20043-9998, US

(73) Assignee: Hauni Maschninenbau AG, Hamburg (DE)

(21) Appl. No.: 10/569,843

(22) PCT Filed: Aug. 30, 2003
(86) PCT No.: PCT/EP03/09654

§ 371 Date: Nov. 14, 2006

(51) Int. Cl. G05B 15/00

(52) U.S. Cl. 700/83

(57) ABSTRACT

A display and operating system for a machine in the tobacco-processing industry includes a visual display unit for the display of screen displays, and a data processing unit which is programmed to generate the screen displays and output them to the visual display unit as well as to store actions that can be performed by an operator. Each stored action is assigned an action screen display, and a sequential display of action screen displays is activatable. For every stored action in the data processing unit, it can be stored variably whether this action is necessary, the display sequence including all action screen displays stored as necessary. The subject of the application is also a corresponding display and operating method.

The invention concerns a display and operating system for a machine in the tobacco-processing industry, with a visual display unit for the display of screen displays, a data processing unit which is programmed to generate the screen displays and output them to the visual display unit as well as to store actions that can be performed by an operator, wherein each stored action is assigned an action screen display, and wherein a sequential display of action screen displays is activatable. The invention further concerns a corresponding display and operating method.

From EP 1 225 491 A1 is known a display and operating system with which an operator can make a change of configuration of a cigarette-making machine, in particular in connection with a change of brand or format. After selection of a target configuration, a list of the actions necessary for the change of configuration is displayed in a screen display (summary display). Beginning with the first action from this list, a sequence of action screen displays (detail displays) necessary for the change of configuration is displayed in a fixed order.

It is the object of the present invention to provide a display and operating system as well as a corresponding method which assists the operator in carrying out actions during machine operation.

The invention achieves this object by the characteristics of independent claims 1 and 22, in particular by the fact that for every stored action in the data processing unit it can be stored variably whether this action is necessary, wherein the display sequence includes all action screen displays stored as necessary.

By means of the invention, all action screen displays for actions to be performed are displayed to the operator successively in an appropriate order and without omissions, in order to achieve or maintain problem-free operation of the machine. Clear guidance of the operator by the individual action screen displays of the display sequence leads to increased user-friendliness, and also the risk of operating errors is reduced. In particular, the invention is not confined to changes of configuration of the machine selected by the operator, as is the case in the state of the art. If, for example, a given action is to be performed at a given time in order to achieve or maintain problem-free operation of the machine, display of the corresponding action screen display is not ensured in the state of the art in a display sequence for a selected change of configuration, as there is no display in the event that the action screen display is not necessary for the selected change of configuration. The actions stored as necessary according to the invention, on the other hand, reflect an objective actual state of the machine, independently of an operator's subjective wishes for change.

The term “action that can be performed by an operator” is to be understood broadly. This can mean manual or mechanical changes or adjustments to the machine or parts of the machine or calibrations. Further, it can mean entries in the data processing unit, for example, with a touch-sensitive screen, for example, for shifting or adjusting machine or brand parameters, or other operator actions.

Essential to the invention is the variable storage of the necessity of the actions in the data processing unit. On account of the variability of this storage, at any time a current image of all currently necessary actions can be obtained. In particular there is the preferred option of setting or changing unnecessary (or no longer necessary actions) to “unnecessary”.

Particularly preferred, therefore, is dynamic adaptation of the display sequence to changes arising in the course of the display sequence and connected with actions. The term “changes connected with an action” is to be understood broadly. This can mean entries by the operator in a screen display. It can also mean manual changes or shifting of machine devices. Further, it can mean changes of status which occur without any action by the operator and which can be detected automatically with measuring devices. These changes can in particular lead to a change in the necessity of actions. If, for example, an action screen display becomes no longer necessary only in the course of the display sequence, displaying it subsequently can be dispensed with. This improves the user-friendliness, as the operator is not confronted with unnecessary and therefore superfluous action screen displays. Adaptation of the display sequence may also consist in that only some out of a plurality of possible action screen displays are displayed, or in changing the representation of the action screen displays to be displayed.

Variable storage may be achieved, for example, by assigning each action a status storage variable which indicates whether the action is currently necessary or not. This is, however, not the only possible solution. It is conceivable, for instance, to make the necessity of actions known by means of their arrangement, or their allocation to different storage areas. Variable storage takes place appropriately by means of a variable storage device such as RAM, hard disk and the like.

Machines in the tobacco-processing industry include in particular cigarette production machines including filter cigarette production machines, filter production machines, cigarette storage systems, cigarette packing machines, material delivery apparatuses for these machines and other apparatuses associated with these machines.

“Screen display” denotes a graphic representation reproduced on the screen. The term “screen mask” is also used for this. It can also be simply a given area of the screen, for example, a so-called window. The combination of screen displays forms a graphic user interface.

Necessary action screen displays are screen displays which are assigned to necessary actions, that is, actions which are stored as “necessary” in the data processing unit. For instance, an action connected with a parameter can be necessary if the actual value of this parameter deviates from the range of nominal values. It is therefore possible that, as a result of a detection of measurements, a corresponding action (for example “Change parameter”) is set to “necessary” when the measurement is outside the range of nominal values. An action may further be necessary when an action on which the first-mentioned action is dependent is necessary or selected or when a change connected with the first-mentioned action has been made. Preferably, therefore, when an action is set to “necessary”, it is selected or a change connected with it is made, testing is carried out as to whether the dependent actions become necessary as a result, and, if need be, setting of the status storage variables of the dependent actions to “necessary” is carried out.

Appropriately, after successfully performing or working through a necessary action, this action is set to unnecessary. Also preferably there is provision for the possibility of setting all necessary actions to unnecessary irrespective of whether they have been performed or worked through by means of the user interface. Such resetting can become necessary as an exception. Preferably, no further options of setting actions to unnecessary are provided for the operator in order to be able to not easily disable the predetermined optimum action cycles. In particular, preferably necessary actions continue to be necessary after possible premature termination of a display sequence by the operator, and are thus displayed in a subsequent display sequence, as problem-free operation still depends on performing these actions.

An action is dependent on another action when a change connected with this other action as a rule necessitates the first-mentioned action. (It is not absolutely necessary for a change connected with the second action to actually necessitate the first-mentioned action; for example, minor changes can make a dependent action unnecessary, while major changes of the same kind do not.) The mutual dependencies of all actions are established from the outset for a given machine, i.e. they are invariable during operation of the machine. They can therefore be stored in a memory as permanent storage quantities, for example, as storage constants. The dependencies can be stored in a permanent memory, but also in a variable memory. The difference from storage of necessity lies in that the dependencies cannot be altered during operation of the machine.

Since, at a given moment of a display sequence, it is not yet established whether changes are actually made in the present or subsequent action screen displays and therefore the dependent actions actually become necessary, the number of potentially necessary actions, i.e. the necessary and selected actions including the actions dependent on them, is as a rule larger than the number of actions that are actually necessary in the course of the display sequence. These potentially necessary actions can be displayed in the form of a preview list which indicates to the operator all actions that are potentially still to be worked through. If now, for example, a selected action is not changed, the actions dependent on it become unnecessary and are then no longer contained in a subsequently generated preview list.

In a particularly preferred embodiment, actions can be selected by the operator. Corresponding actions are to be performed, for example, in case of a change of brand, change of format, first starting up the machine or restarting it. In this case appropriately—in addition to the necessary action screen displays—the action screen displays selected by the operator are displayed in the display sequence even if they are not stored as necessary.

Preferably the action screen displays within the display sequence are displayed in a preferred order which results from performing these actions chronologically in order to keep the effort for the operator as low as possible. If, for example, one action depends on another, appropriately the dependent action screen display is displayed only after the other action screen display, because otherwise the dependent action screen display would have to be displayed repeatedly.

The display and operating system is appropriately interactive. For the entry of information in the system by an operator, an input device is therefore appropriately provided. The latter can also be produced in the visual display unit itself, for example, if it is a touch-sensitive screen.

Further advantageous characteristics and embodiments of the invention are apparent from the subsidiary claims and the following description of the invention with reference to the attached drawings. These show:

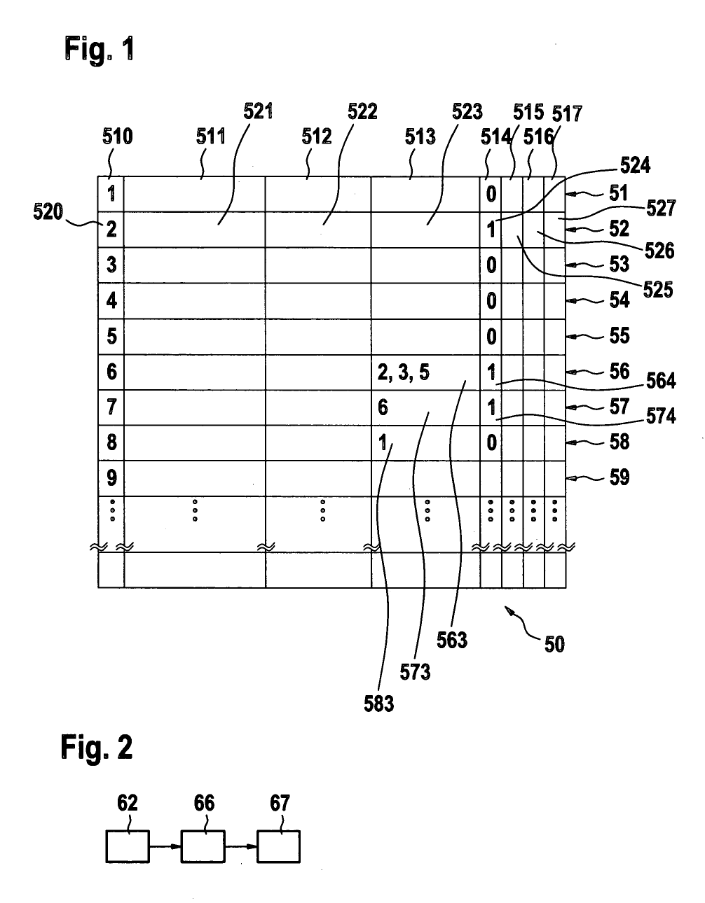

FIG. 1: a schematic view of an internal action table;

FIG. 2: a schematic view of the display sequence of action screen displays according to the action table shown in FIG. 1;

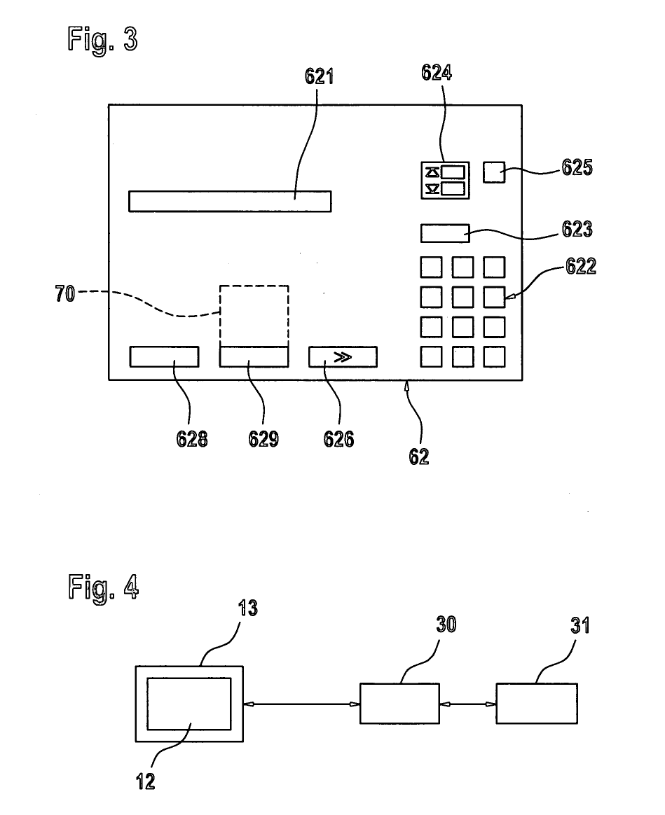

FIG. 3: a schematic view of an action screen display;

FIG. 4: a schematic view of a display and operating system for a machine in the tobacco-processing industry;

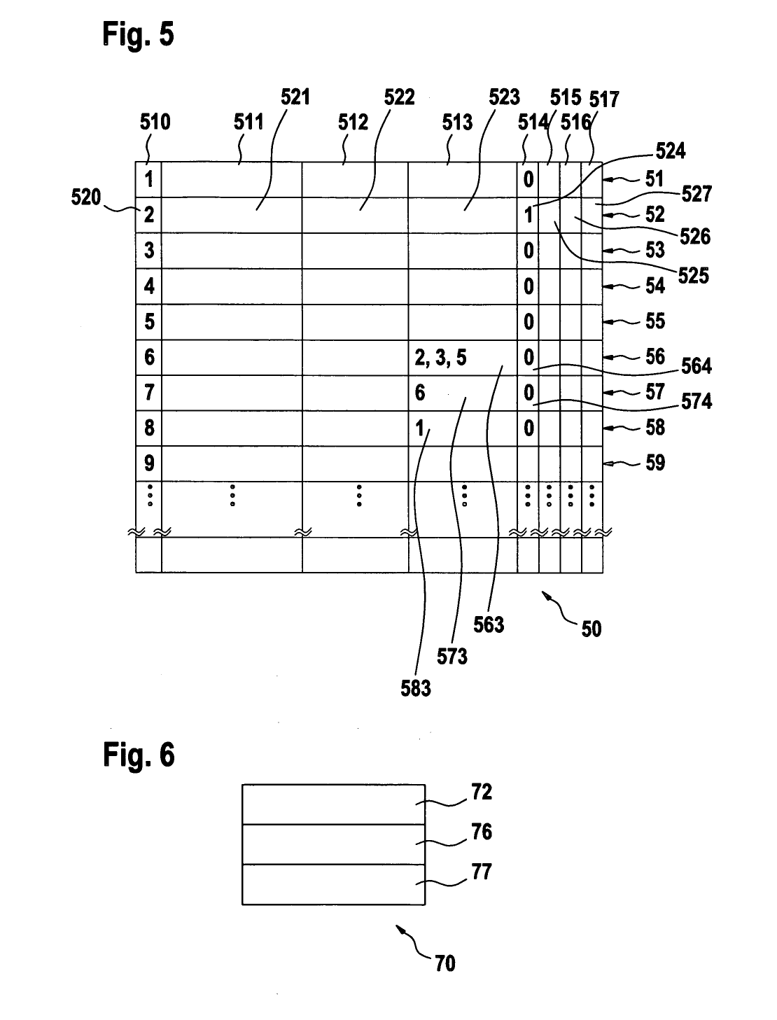

FIG. 5: a further schematic view of an internal action table;

FIG. 6: a preview list according to the action table shown in FIG. 1 or FIG. 5;

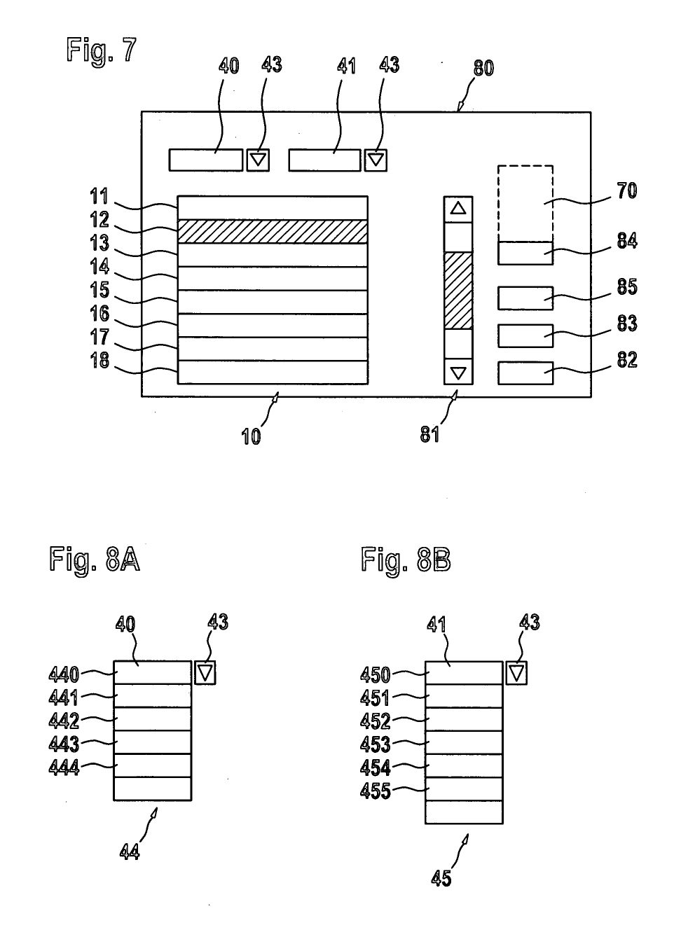

FIG. 7: a schematic view of a list screen display;

FIG. 8: a schematic view of the target selection areas of the list screen display shown in FIG. 7 in the activated state;

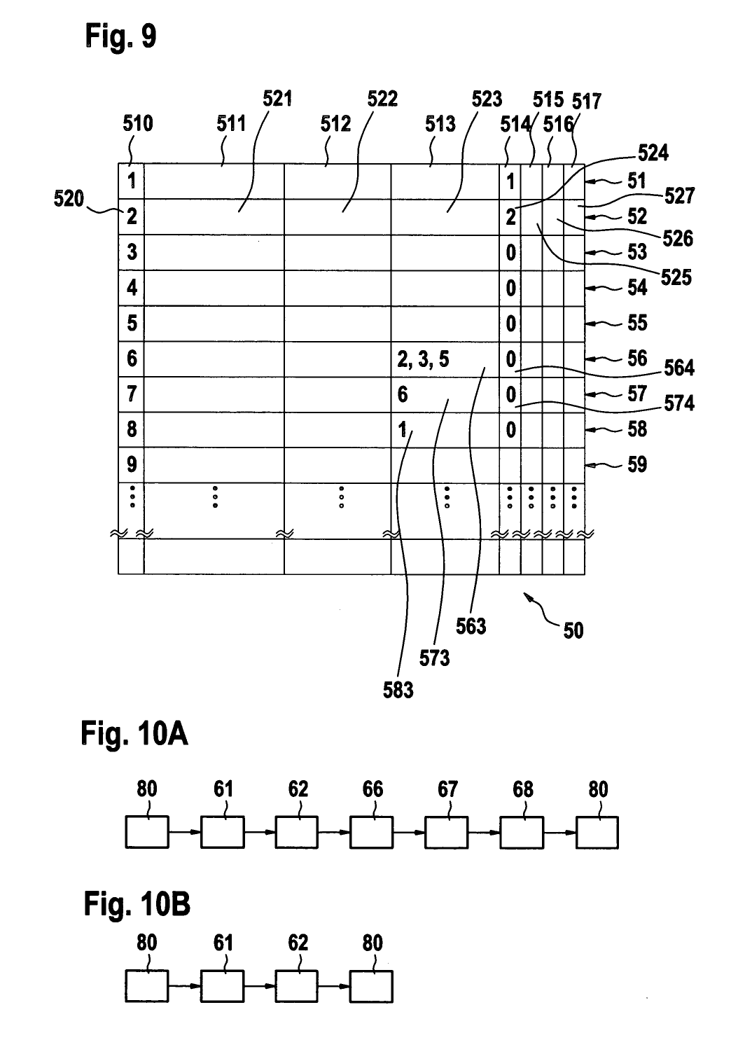

FIG. 9: a schematic view of an internal action table according to the list shown in FIG. 7;

FIG. 10: a schematic view of the minimum and maximum display sequences of action screen displays according to the action table shown in FIG. 9; and

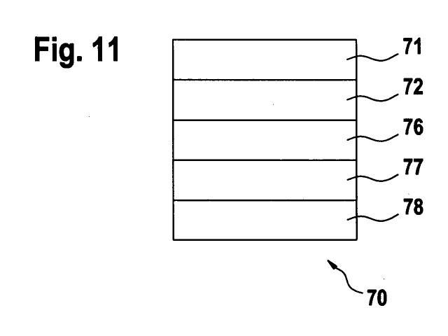

FIG. 11: a preview list according to the action table shown in FIG. 9.

The cigarette production machine 31 is connected to the data processing unit 30 which can, for example, include a personal computer and which is connected to the touch-sensitive visual display unit 13 for the display of graphic screen displays 80, 61, 62, 63, . . . Measurement data of the cigarette production machine 31 are displayed via the data processing unit 30 on the visual display unit 13. Conversely, data entered in the visual display unit 13 designed as a terminal are forwarded via the data processing unit 30 to the cigarette production machine 31 for the control thereof.

In the personal computer of the data processing unit 30 or in a data bank is stored the internal action table 50. Each line 51, 52, 53, . . . of the internal action table 50 is assigned to an action that can be performed by the operator. FIG. 1 shows only a detail of the whole internal action table 50 which as a rule includes more than one hundred actions. Each line 51,52, 53, . . . comprises a row of fields 510, 511, 512, . . . ; 520, 521, 522, . . . ; 530, 531, 532, . . . ; . . . (in FIG. 1 the areas of the rows 53, 54, . . . are no longer marked for reasons of clarity). The fields 510, 520, 530, . . . of the first column contain a consecutive number. The fields 511, 521, 531, . . . of the second column contain the description of the assigned action, for example, field 511 “Calibrate overshoot sensors”, field 521 “Adjust tobacco stick0 length”, field 531 “Adjust nominal cigarette weight”, field 541 “Set overshoot control mode”, field 551 “Adjust nominal overshoot value”, field 561 “Adjust total tobacco quantity”, field 571 “Adjust approach correction”, field 581 “Calibrate overshoot measurement”, etc. The fields 512, 522, 532, . . . of the third column contain information on individual action elements which are encompassed by the respective action. For instance, the action of line 51 “Calibrate overshoot sensors” concerns the adjustment of a plurality of individual machine parameters. The fields 513, 523, 533, . . . of the fourth column contain correlations between the respective actions and other actions which will be described later. The fields 514, 524, 534, . . . of the fifth column contain variable notification or storage of whether the corresponding actions are necessary. Here, the entry “1” means necessary, and the entry “0” unnecessary. The entries of the sixth, seventh and eighth columns of the internal action table 50 will be described later. The internal action table can have further columns or dispense with columns shown in FIG. 1 (for example, the first or third column).

In the example of FIG. 1, the actions assigned to lines 52, 56 and 57 are necessary. Therefore upon activation of the display sequence corresponding action screen displays 62, 66, 67 are displayed. Preferably, the actions in the internal action table 50 are arranged in the preferred order of carrying them out. Hence first the action screen display 62 assigned to the action “Adjust tobacco stick length” (line 52) and shown by way of example in FIG. 3 is displayed. This includes a display area 621 with the description of the corresponding parameter “Tobacco stick length” and the nominal value stored for it, a number keypad 622 for entry of a value in an input area 623, a display area 624 for the display of upper and lower limits for the value to be adjusted, and a button 625 for the entry of a preset value in the input area 623. Display of the keypad 622 can also be activatable only as required. In the action screen display 62 additional information can be displayed, if necessary, for example, context-sensitive help, a graphic display of regions of the machine concerned, etc.

When the action of line 52 has been performed by the operator, that is, the tobacco stick length adjusted, the area 524 is set to “0”, i.e. to unnecessary (no longer necessary), and the “Continue” button 626 leads to display of the next necessary action screen display 66 which is assigned to line 56 of the internal action table 50. After performing the corresponding action “Adjust total tobacco quantity”, field 564 is set to “0”, i.e. to unnecessary (no longer necessary), and by actuating the “Continue” button in the action screen display 66 (not shown), the next necessary action screen display 67 which is assigned to line 57 of the internal action table 50 is displayed. In this way, as shown in FIG. 2, a sequence of necessary action screen displays 62, 66, 67 is displayed in appropriate sequence of handling.

It may be provided that actuation of the “Continue” button in an action screen display is possible only when the action assigned to this action screen display is actually performed by the operator. The “Continue” button can then be shown as inactive until this action is performed, for example, by light instead of black type. This can concern in particular the necessary action screen displays.

Preferably, each action screen display has a “Continue” button. In this way the display sequence is run through in a predetermined unique manner. Preferably, as in the example of FIG. 2, essentially each action screen display 62, 66 is uniquely assigned precisely one immediately following action screen display 66 or 67. “Essentially” means up to the last action screen display 67 of the display sequence, to which this does not have to apply. It is, however, also conceivable that in an action screen display the user is offered two or more alternatives for the immediately following action screen display. An action screen display in this case could also have two or more “Continue” buttons. Generally, the activation of an immediately following action screen display can also take place otherwise than by means of a “Continue” button.

Actuation of the “End” button 628 ends the display sequence prematurely. For example, a return to a screen display displayed before activation of the display sequence can then take place. If, in the example of FIGS. 1, 2, the display sequence in the action screen display 62 is ended prematurely, the action screen displays 66, 67 continue to be stored as necessary. This note property of the fifth column of the internal action table is connected with the fact that the latter describes an actual state of the machines and the corresponding actions are still necessary for problem-free machine operation. A subsequently activated display sequence would therefore include the action screen displays 66, 67 still necessary.

In order to return to the preceding action screen display, for example, to correct an entry, a “Back” button can be provided. By repeated actuation of the corresponding “Back” buttons, any preceding action screen display can be reached. In another embodiment “Back” buttons can be dispensed with for the sake of unambiguous user guidance.

In the state shown in FIG. 5, the action assigned to line 52 is necessary, whereas by contrast with FIG. 1 the actions assigned to lines 56, 57 are unnecessary (areas 564, 574 are set to “0”). In area 563 it is permanently stored—here by means of the number “2”—that the action of line 56 depends inter alia on the action of line 52. This means that a change in connection with the action “Adjust tobacco stick length”, here in particular a shift of the parameter “Tobacco stick length”, as a rule necessitates the action “Adjust total tobacco quantity”. The number “6” in area 573 indicates that the action “Adjust approach correction” of line 57 depends on the action “Adjust total tobacco quantity” of line 56. In the state shown in FIG. 5, i.e. before or during display of the action screen display 62, the actions of lines 56, 57 are not essentially necessary as long as a change in connection with the action 52 has not yet taken place. After a change in connection with the action 52, here in particular after the shift of the parameter “Tobacco stick length”, the actions of lines 56, 57 may however become necessary. This is checked with a computer program and if necessary the actions of lines 56, 57 are set to necessary by setting the areas 564, 574 to “1”. If, however, there is no change in connection with action 52, i.e. the parameter “Tobacco stick length” is left unchanged in the action screen display 62 and instead the “Continue” button 626 is actuated, then the dependent actions of lines 56, 57 become unnecessary, hence the fields 564, 574 remain set to “0” and subsequent display of the action screen displays 66, 67 can be dispensed with. (Instead it is, for example, also conceivable to display the action screen displays 66, 67 with a clearly visible “Unnecessary” tag in the display sequence, so that only the “Continue” button would have to be actuated in the action screen displays 66, 67.)

According to the above, in the state shown in FIG. 5 the actions of lines 56, 57 are potentially necessary because, depending on changes made in connection with preceding actions, as a rule they become necessary or not. Preferably, a preview list of all currently necessary and potentially necessary actions can be displayed. In the action screen display 62, the preview list 70 can be displayed by actuation of the “Preview” button 629. In FIG. 3 the preview list 70 is shown in broken lines to indicate that the preview list 70 is preferably displayed only temporarily at the request of the operator, for example, as a pop-up field. The preview list 70 includes a list of fields 72, 76, 77 for describing the necessary action of line 62 of potentially necessary actions of lines 66, 67. The contents of fields 72, 76, 77 can, for example, be taken from the second column of the internal action table 50, here fields 521, 561, 571. Preferably, each action screen display has a “Preview” button.

If no change is made in connection with action 52, for example, a machine parameter which is variable in the action screen display 62 (here “Tobacco stick length”) is left unchanged and instead the “Continue” button 626 is actuated, then a subsequently activated preview list contains none of the fields 72, 76, 77, as the action of line 52 is done and therefore no longer necessary, while the actions of lines 56, 57 have become unnecessary. The preview list could then be empty.

In the state shown in FIG. 1, the preview list 70 shown in FIG. 6 would also be displayed.

The list screen display 80 shown in FIG. 7 includes an index list 10 with a plurality of lines 11, 12, 13, . . . , each line being assigned an action that can be performed. Depending on the length of the index list 10, a scrollbar 81 can be provided for shifting the display area of the index list 10. In the index list 10, single or multiple actions can be selected by the operator. If the visual display unit 13 is a touch-sensitive screen, the selection of single actions can take place, for example, by touching the lines of the index list 10 to be selected. By means of the button 83 all actions of the index list 10 can be selected; this can ensure in a simple manner that all actions to be performed are contained in the display sequence. The information entered by the operator is processed by the data processing unit 30. The selected actions are set to “selected” in the fifth column of the internal action table 50 (number “2”, see FIG. 9) if they are not already set to necessary; the selected actions set to necessary remain set to necessary. The selection of individual lines is visibly confirmed for the operator, for example, by graphic highlighting. In the example of FIG. 7 line 12 is selected.

If in FIG. 7 the “Assistant” button 82 is actuated, the successive display of action screen displays is started. The display sequence includes the actions stored in the internal action table 50 (see FIG. 9) as necessary and those stored as selected. In the example shown in FIGS. 7, 9, therefore, on starting the display sequence at least the action screen displays 61 and 62 would be contained in the display sequence (see FIG. 10B). In case of a change connected with the action of line 51, the display sequence can continue to include the action screen display 68 dependent on it (see number “1” in field 583 of the internal action table). In case of a change connected with the action of line 52, the display sequence can continue to include the action screen displays 66, 67 dependent on it. If all potentially necessary actions actually become necessary in the course of the display sequence, the maximum display sequence shown in FIG. 10A results. The preview list 70 which can be displayed in the list screen display 80 with the “Preview” button 84, would have the form shown in FIG. 11. This preview list 70 can change in the course of the display sequence, in particular if the potentially necessary actions of lines 56, 57 or 58 do not actually become necessary, and display of the corresponding action screen displays 66, 67 or 68 and hence also fields 76, 77 or 78 can be eliminated in a preview in the course of the display sequence.

As can be seen from FIG. 10, the total number of individual action screen displays of a display sequence depends on changes taking place in the course of the display sequence in connection with actions.

In case of premature ending of the display sequence, the necessary actions remain set to necessary, while the actions set to selected (number “2” in FIG. 9) are reset to unnecessary (number “0”). Then, for example, the list screen display 80 can be displayed. In general, a return to the screen display which was displayed before the start of the display sequence can take place. This does not have to be the list screen display 80, as the display sequence can also be activatable from other screen displays. There may also be provision for automatic activation of the display sequence as a result of certain events. By means of the button 85 in the list screen display 80, all actions set to necessary can be set to unnecessary in the fifth column of the internal action table 50 (number “0”).

The actions in the index list 10 are preferably arranged in an appropriate order of handling. The index list 10 may have a further column corresponding to the fifth column of the internal action table for display of the status of each action displayed in the index list 10. For reasons of clarity, the display of this column may also be dispensed with.

The list screen display 80 serves in particular to assist the operator in performing actions in connection with brand and format changes, first start-up of the machine, restarting for example after repair, and/or machine adjustments independent of a change of brand. For this purpose, first all actions that can be performed by the operator at all can be displayed in the form of a single index list 10 within a single screen display, namely the list screen display 80. This characteristic is apt to distinguish the present application from the state of the art and is therefore, if necessary, independent, i.e. can be claimed only with reference back to the introductory part of claim 1.

In the list screen display 80 are provided target selection fields 40 and 41 for the selection of action targets by the operator, by means of which the actions displayed in the index list 10 can be limited to certain actions assigned to the selected action targets. Each of the target selection fields 40, 41 has a button 43 whose actuation leads to the display of an associated target selection list 44, 45. The target selection lists 44, 45 each include a plurality of list fields 440, 441, 442, . . . ; 450, 451, 452, . . . For instance, by touching a list field 440, 441, 442, . . . , 450, . . . , an action target displayed in this list area is transferred to a respective target selection field 440, 450 of the target selection lists 44, 45 and so selected.

The target selection list 44 includes, for example, the action targets “Brand and machine adjustments” (in particular for first starting up)”, “Machine adjustments (in particular when a brand is loaded)”, “Brand and format changes”, “Brand change without format change”, “Restart after repair”. By selection of the Brand change action target, only those actions which are necessary for a change to the desired cigarette brand are displayed in the index list 10. By selection of the Machine adjustments area, only machine adjustment actions independent of a change of brand are displayed in the index list 10.

The target selection list 45 concerns different machine regions and includes, for example, the action targets “Whole machine”, “Distributor”, “Rod maker”, “Filter assembler”, “Paper supply”, “Printer”. By selection of one of these action targets, only those actions which concern the selected machine region are displayed in the index list 10. The action target “Whole machine” includes all of the other action targets of the target selection list 45. The action target “Whole machine” therefore gives the skilled operator an overview and hence quick access to the corresponding actions, without having to perform additional operating steps or having to work through a plurality of hierarchically structured screen displays. For the less skilled user it may be clearer to narrow down the actions displayed in the index list 10, for example, by selection of a machine region in the target selection list 45. Similar applies to the target selection list 44 in relation to the action target “Brand and machine adjustments”.

There may also be provided a target selection list, not shown, in relation to certain events in relation to the machine. After selection of one of the corresponding action targets, only the actions which are necessary after the selected event are displayed in the index list 10. Selection of a given event from the target selection list 44 may be sensible, in particular in connection with the action target “Restart after repair”, in order to specify more precisely the type of repair done. Preferably, therefore, the said target selection list can be displayed only if the area “Restart after repair” is selected in the target selection list 44. In another embodiment the above-mentioned target selection list and a corresponding target selection area are dispensed with.

In the sixth to eighth and, if necessary, further columns of the internal action table 50, for example, assignment of the actions to the respective target selection lists and/or the respective action targets can be permanently stored.

According to the above, the different action targets of the target selection lists 44, 45 constitute filters for the actions to be displayed in the index list 10. It is therefore possible to combine a selection of action targets of the target selection fields 40, 41, for example, “Brand change” in target selection field 40 and “Rod maker” in target selection field 41, which leads to display of the actions necessary for a brand change in relation to the rod maker in the index list 10.

After selection of a target action, display of the respective target selection list 44, 45 is deactivated again, so that at any given time only the target selection fields 440, 450 with the respectively selected action target remain on display. Preferably, only one target selection list 44, 45 can ever be activated at a time. If one of the target selection lists 44, 45 is activated, the index list 10 can as a result be partly concealed (for example, in the arrangement shown in FIG. 7). Nevertheless, the index list 10 remains at least partly visible. The user-friendliness is not impaired by this, as display of the respective target selection list 44, 45 is deactivated again after selection, and the list is then unconcealed again; the index list 10 is therefore always concealed only partly and only for a short time. Alternatively the target selection fields 40, 41 can also be arranged in such a way that the index list 10 remains completely unconcealed even when the target selection list 44, 45 is activated (in FIG. 7, for example, by display of the target selection lists 44, 45 above the target selection fields 40, 41).

According to the above, both the index list 10 and the at least one target selection field 40, 41 are arranged in the same list screen display 80. Both the target selection field 40, 41 and the index list 10 are therefore at least partly visible to the operator together or simultaneously in the list screen display 80. The contents of the index list 10 change dependent on the action target selected in the target selection field 40, 41, without a possibly confusing change of screen display taking place. After selection of an action target, the target selection field 40, 41 remains visible in the list screen display 80, so that reselection of another action target can be performed without effort. In this way an overview of the actions to be performed or the relevant adjustments can be obtained quickly and clearly for various action targets. Preferably, the arrangement and design of the index list 10 and target selection field 40, 41 in the list screen display 80 are essentially unchanged, so that the operator perceives the list screen display 80 in any case as a single screen display with respect to the index list 10 and the target selection field 40, 41.

Display of the index list 10 can, at the end of a display sequence, be updated to the effect that the display of actions already performed therein is dispensed with, or they are marked as already performed for the operator.

1. Display and operating system for a machine in the tobacco-processing industry, with a visual display unit for the display of screen displays, a data processing unit which is programmed to generate the screen displays and output them to the visual display unit as well as to store actions that can be performed by an operator, wherein each stored action is assigned an action screen display, and wherein a sequential display of action screen displays is activatable,
characterised in that for every stored action in the data processing unit it can be stored variably whether this action is necessary, the display sequence including all action screen displays stored as necessary.

2. Display and operating system according to claim 1, characterised in that the display sequence is dynamically dependent on changes arising in the course of the display sequence and related to actions.

3. Display and operating system according to claim 1, characterised in that for every stored action in the data processing unit it can be stored permanently on which other actions the action concerned is dependent.

4. Display and operating system according to claim 1, characterised in that, as a result of a change connected with an action, actions dependent thereon are set to necessary.

5. Display and operating system according to claim 1, characterised in that actions can be selected by the operator.

6. Display and operating system according to claim 5, characterised in that a display sequence activated after selection of action screen displays includes the selected action screen displays.

7. Display and operating system according to claim 5, characterised in that all selectable actions can be selected simultaneously.

8. Display and operating system according to claim 1, characterised in that a preview list of the selected and/or necessary action screen displays as well as of the action screen displays dependent thereon can be displayed.

9. Display and operating system according to claim 8, characterised in that display of the preview list in caused upon a separate request by the operator.

10. Display and operating system according to claim 1, characterised in that display of an action screen display of the display sequence is caused by activation in an immediately preceding action screen display.

11. Display and operating system according to claim 1, characterised in that a subsequent action screen display can be activated only after performing the current action.

12. Display and operating system according to claim 1, characterised in that, as a result of performing an action, this action is set to unnecessary.

13. Display and operating system according to claim 1, characterised in that in the or each action screen display the display sequence can be ended prematurely.

14. Display and operating system according to claim 13, characterised in that actions stored as necessary continue to be stored as necessary after premature ending of the display sequence.

15. Display and operating system according to claim 1, characterised in that all actions can be simultaneously reset to unnecessary.

16. Display and operating system according to claim 1, characterised in that all actions that can be performed by the operator can be displayed in a list screen display.

17. Display and operating system according to claim 16, characterised in that all actions that can be performed by the operator are displayed in the form of a single index list.

18. Display and operating system according to claim 16, characterised in that the list screen display includes at least one target selection field with a plurality of selectable action targets, wherein the actions displayed in the list screen display are determined by the action target selected at any given time.

19. Display and operating system according to claim 18, characterised in that a target selection field is provided for the selection of action targets in connection with brand and/or format changes, machine adjustments or starting up the machine.

20. Display and operating system according to claim 18, characterised in that a target selection field is provided for the selection of action targets in connection with different machine regions.

21. Display and operating system according to claim 1, characterised in that the action screen displays of a display sequence, the actions stored in the data processing unit and/or the actions displayed in the list screen display are arranged in an appropriate order.

22. Display and operating method for a machine in the tobacco-processing industry for the display of screen displays on a visual display unit, with a data processing unit for storing actions that can be performed by an operator, each stored action being assigned an action screen display, including the steps of:
activating a sequence of action screen displays,
displaying the activated display sequence of action screen displays,
characterised in that for every stored action it is stored variably whether this action is currently necessary for machine operation,
wherein all action screen displays stored as necessary are displayed in the display sequence.
